(19) United States
(12) Patent Application Publication
(10) Pub. No.: US 2004/0059777 A1
(43) Pub. Date: Mar. 25, 2004

(54) System and method for distributed component object model load balancing

(76) Inventors: Craig M. Palazzo, Grand Rapids, MI (US); Todd W. Powers, Rockford, MI (US)

Correspondence Address: ALTICOR INC., 7575 FULTON STREET EAST MAILCODE 78-2G, ADA, MI, 49355, US

(21) Appl. No.: 10/449,660

(22) Filed: May 30, 2003

Related U.S. Application Data
(60) Provisional application No. 60/385,156, filed on May 31, 2002.

(51) Int. Cl. G06F 15/16

(52) U.S. Cl. 709/203; 719/316

(57) ABSTRACT

The present invention relates to a system and method for dynamically balancing a load among a cluster of network Servers. More particularly, this invention relates to A method for balancing Distributed Component Object (DCOM) calls among a plurality of computers, said plurality of computers comprising a client computer, a server computer, and a cluster device, said cluster device being coupled by a network to said client computer and said server computer, wherein the method comprises issuing a request, by the client computer, to the server computer for the Internet Protocol (“IP”) address of the server computer, providing, by the server computer, the IP address of the server computer to the client computer, and instantiating, by the client computer, a DCOM component on the server computer.

This application claims the benefit under 35 U.S.C. §119(e) of U.S. provisional patent application Serial No. 60/385,156 entitled System and Method for Distributed Component Object Model Load Balancing, which was filed on May 31, 2002.

### COMPUTER PROGRAM LISTING APPENDIX

The specification herein contains a computer program listing appendix submitted on one compact disk, including a duplicate disk. The compact disk contains one file. The file is named Mylnet.TXT, and has a creation date of May 30^{th}, 2003, and is 15,000 bytes in size. The contents of this disk are hereby incorporated by reference.

### BACKGROUND OF THE INVENTION

The present invention relates generally to the field of distributed computing systems, and more specifically to computing system networks and methods for balancing distributed component object model requests among one or more network Servers within a cluster of Servers. The proliferation of computer network services needs little introduction. The explosive growth of computer networks, such as the Internet and Intranet services, has brought computer networking to many homes and businesses. Network users have come to rely on Internet/Intranet services for reliable and efficient access to information, and for a reliable and efficient means for conducting business.

A computer network is generally comprised of two or more computers, with each computer in communication with at least one other computer. Typically, computer networks are designed around the Client/Server model of information delivery. Client/Server describes the relationship between two computer programs in which one program, the Client, makes a service request from another program, the Server, which fulfills the request. The Client/Server model provides a convenient way to interconnect programs that are distributed efficiently across different locations. One example of a Client/Server model of information delivery is a standard electronic mail (“e-mail”) system. Typically, when a user checks e-mail from a computer, a Client program on the users computer sends a request over a network to a program residing on a Server computer operated by the users Internet Service Provider (ISP). The computer program running on the ISP Server retrieves the contents of the requested e-mail, and sends the e-mail to the Client program on users computer, which then allows the user to read the e-mail.

A computer network is further comprised of the equipment that facilitate the communication between the Client and Server. This equipment may include cables, modems, routers, wireless transmitters and receivers, load balancing devices, and other hardware components. A more complete description of networks, and in particular, the Internet, can be found in “How the Internet Works”, 6^{th} edition by Preston Gralla, copyright 2002 by Que, the subject matter of which is hereby incorporated by reference.

The growth of Internet and Intranet services has fed a demand for increased network performance, maintainability, scalability, and reliability. Existing technologies such as the Component Object Model (COM) address some of these demands. COM is a software protocol that allows for the construction of applications using discrete reusable and distributable building blocks of code, or Components. These Components can be combined to create computer applications or programs. COM allows software developers to build applications or programs by assembling reusable Components. These Components communicate with the program or application, or each other, via the COM protocol. In the most basic embodiment, a computer application directly calls a Component through that Component's interface, without the need for any intermediary system Component. The Component then returns a response and the computer application continues operation. One Example of a simple COM Component is a single button in a graphical user interface.

When software developers create applications, they can utilize the Components. The developers will not be required to re-invent the Components. The reuse of COM Components provides other benefits as well. Maintenance or changes to the functionality provided by a COM Component is propagated to each user of those Components. In business applications, for example, this feature eliminates the need to adjust multiple applications when business rules or strategies change. The user simply makes the alteration to the Components that implement the rule. In this manner, every application using that Component is updated to meet the new business rule or strategy.

Traditionally, the COM protocol only allows communication across process boundaries within the same computer. The Distributed Component Object Model (“DCOM”) published by the Microsoft Corporation of Redmond Wash., extends COM to support communication among computer programs or applications and Components on different computers. For example, DCOM allows computer applications to call Components located on different computers coupled by network, such as a Local Area Network (LAN), Wide Area Network (WAN) or the Internet. DCOM, like COM, allows the creation of reusable and distributable components used to construct computer applications or programs. DCOM simply replaces the local interprocess communication of COM with a network protocol. For example, an application running on a Client computer requires information from a database stored on a Server computer coupled to the Client by a network. Herein, the phrases “coupled with” and “coupled to” are defined to mean directly connected to or indirectly connected through one or more intermediate components. Such intermediate components may include both hardware and software based components. Using the DCOM protocol, the Client calls a Component on the Server. That Component retrieves the required information from the database and returns the information to the Client, and the Client computer continues operation. The DCOM Client application can be any type of Client, including a Visual Basic client, a C++ client, or a Web page using dynamic page generation technologies such as Microsoft's Active Server Pages or ASP.NET. U.S. Pat. No. 6,324,681 issued to Sebesta et al., incorporated herein by reference, provides further detail on the operation and function of DCOM.

DCOM may be further enhanced when used in concert with a cluster of network Servers. Network Servers are often installed on a Server cluster. Clustering of Servers refers to linking Servers both physically and programmatically, allowing the Servers within a cluster to perform common tasks. Network traffic to the Server cluster is routed to one or more of the Servers within the cluster by a load balancing device as described in more detail below. If one Server stops functioning, or is taken off-line, then the workload of that Server may be shifted to another Server within the cluster.

Taking advantage of clustering technologies is desirable in situations where high numbers of Client connections are being made to the Server and/or high levels of availability are desired and/or required. DCOM traffic would be significantly enhanced if it could take advantage of these technologies. DCOM however does not natively provide any support for operation in a load-balanced or clustered environment. Microsoft realizes this is a limitation of DCOM and recommends creating a home-grown solution for your specific load-balancing needs.

In a clustered environment, one Internet Protocol (“IP”) address, typically considered a Virtual Internet Protocal (“VIP”) address is used to represent all of the servers in a cluster. This one address does not represent any single server, but instead is used to route requests to any one of the number of servers which reside behind the clustering device. When the servers issue the response, the clustering device then responds back to the Client on behalf of the server using the VIP address. This type of activity is commonly referred to Network Address Translation (“NAT”) because the clustering device is translating between the Internet Protocol (“IP”) address of the server and the address of the clustering device.NAT is further described in Request For Comment (“RFC”) document 1631, the subject matter of which is incorporated herein by reference.

Due to the nature of the RPC protocol, it can not function properly in an environment where NAT is being used. RPC requires direct communication between the client and the server, with no NAT occurring between the two. Since DCOM relies on the RPC protocol, it inherits these same limitations.

Several methods have been developed to overcome these problems when implementing DCOM within a clustered Server environment. These methods include statically balancing DCOM calls, and dynamically balancing DCOM calls across a Server cluster. Each of these methods are discussed below.

Statically Balanced DCOM

One method of load balancing DCOM traffic to a Server cluster is to permanently assign each Client to a particular Server within the cluster. Because these assignments do not change as network conditions change, this method is called static load balancing. One basic approach is to store the Server unique IP address in a central location, such as a database or a small file located on the Client computer. The Client component simply retrieves the IP address of the Server whenever the Client needs to use services that would be provided by a DCOM call to that Server.

While this type of static resource assignment is simple to implement and maintain, this method has some inherent weaknesses. Each Server within the cluster must perform the services allocated to itself regardless of its current loading condition or capabilities. This produces different load conditions among the different Servers within the cluster, resulting in reduced efficiency of the whole system. In addition, if a Server fails or is taken off-line, the Client components accessing that Server are also taken offline, appear out of service, or return errors to the user. The Client may be unaware of the loss of the Server that has been assigned to respond to service requests from that Client, causing the Client to hang or lock when it attempts to access the offline server.

Dynamically Balancing DCOM

Dynamically balanced DCOM attempts to solve the problems associated with statically balanced DCOM. In particular, dynamically balanced DCOM would allow the automatic rerouting of network traffic away from an unavailable Server and to Servers that are accessible and able to handle the traffic.

Typically, dynamic balanced DCOM load distribution is accomplished by using a referral component. The referral component is a COM or DCOM component in itself. The referral component is used any time an instantiated balanced DCOM interface is needed on a Server. The referral component is accessed by a Client to determine the Server on which a DCOM resource should be created. The referral component accomplishes this by examining the Servers within its cluster, and forwarding new DCOM requests to one of the Servers based on parameters specified by the author of the referral component, such as current Server load, network topology between Client and available Servers, and statistics about past demands of a given user. Every time a Client calls a DCOM resource, the referral component can assign the call to the most appropriate Server available at that moment.

Dynamically Balanced DCOM is also characterized by inherent weaknesses. A typical embodiment of the dynamic balanced DCOM with a referral component requires the placement of the referral component on a single computer accessible by all DCOM Clients. However, this method creates several problems. For example, the placement of the referral component on a single computer creates a single point of failure. If the computer with the referral component fails or is taken off-line, then the entire Web site is jeopardized. In addition to the single point of failure, the Servers are forced to make extra DCOM calls to that central server before making the desired DCOM call to the final chosen server. The application must first call the referral component, which then calls the DCOM component on the appropriate Server. This is exacerbated by the need to instantiate the referral component for every DCOM interface needed by the application.

Although the problem of a single point of failure can be circumvented by simply placing the referral component on every Server that needs one, the performance of the application will be degraded by the requirement that lengthy operations must be performed on every Server in the cluster before the user can begin to use the application.

It is therefore desirable to provide a system and method for balancing network DCOM calls over a plurality of Servers, while avoiding the disadvantages offered by the systems and methods previously known in the art. The present invention solves these, and other problems by providing a system and method that increases network performance, maintainability, and scalability, while reducing or eliminating the weaknesses inherent in traditional DCOM load balancing strategies.

### SUMMARY OF THE INVENTION

The present invention relates to a system and method for balancing DCOM resource requests across a cluster of Servers coupled to a network. One object of the present invention is to provide a system and method to facilitate direct communication between a network Client and a network Server. Another object of the present invention is to provide a system and method to facilitate direct communication between a network Client and a network Server within a Server cluster, thereby reducing the number of data requests from the Client that must pass through a Server cluster load balancing device. A further object of the present invention is to provide a system and method for balancing Distributed Component Object Model (DCOM) traffic across a cluster of network servers by leveraging the ability of commonly available hardware load balancing devices that are inherently well adept at load balancing other types of network traffic such as HTTP requests across a cluster of Servers. More particularly, this invention relates to a system and method that allows a Client computer application to access DCOM resources located on a plurality of network Servers. According to one embodiment of the present invention, a Client computer transmits an HTTP request which returns an HTTP response containing the Internet Protocol (IP) address of a particular Server computer within a Server cluster to which the HTTP request was load balanced onto. This HTTP request is routed by a hardware load balancing device to a Server within the cluster using standard HTTP load balancing techniques known in the art. The Server that receives the HTTP request then provides the Client with a response that contains the Servers own unique IP address. Using the IP address from the response, the Client can make the DCOM call directly to that particular Server. The system and method of the present invention thereby leverages the load balancing devices ability to distribute HTTP loads across a Server cluster to balance DCOM traffic across the same Server cluster.

### BRIEF DESCRIPTION OF THE DRAWINGS

FIG. 1 shows a Web site with a three-tiered Distributed Internet Architecture.

FIG. 2 shows a request from a Client to the Web site.

FIG. 3 shows a request from a Client directed by a load balancing device to a particular Server within a Server cluster.

FIG. 4 shows a presentation-layer Server making a request from the business-layer cluster through the business-layer load balancing device.

FIG. 5 shows the business-layer load balancing device directing a request to the appropriate business-layer Server.

FIG. 6 shows a business-layer Server responding directly to a presentation-layer Server.

FIG. 7 shows a presentation-layer Server making a DCOM call directly from a business-layer Server.

### DETAILED DESCRIPTION OF THE ILLUSTRATED EMBODIMENT

The detailed descriptions which follow are provided in the context of an Internet based electronic commerce World Wide Web site and its requirements. As known to those skilled in the art, the term “World Wide Web” (Web) generally refers to the collection of computer resources that can be accessed using various information protocols, such as HyperText Transfer Protocol (HTTP), File Transfer Protocol (FTP), telnet, Usenet, and other protocols. A Web site is generally a set of interconnected Web pages, usually including a homepage, prepared and maintained as a collection of information by a person, group, or organization. Typically, a Web site is accessed over a network by a user through Web browser software, such as Internet Explorer, published by Microsoft Corporation, or Netscape Navigator, published by Netscape Communication Corporation, located in Mountain View, Calif.

For purposes of disclosure, embodiments of the present invention will be described in connection with a electronic commerce Web site, and more specifically in connection with responding to a request from a customer to purchase a product from an electronic commerce Web site. Although described in connection with this particular application, it would be apparent to one skilled in the art that the present invention is not restricted to responding to purchase requests, and will work with any application in which a Client makes a DCOM call to a Server. It would also be apparent to one skilled in the art that the present invention is not restricted to use within an electronic commerce Web site, and is well suited for use with any other type of Web site, such as Web sites that provides news, music, Web logs (“blogs”), or any other network configured to allow a Client to make a DCOM call to a Server.

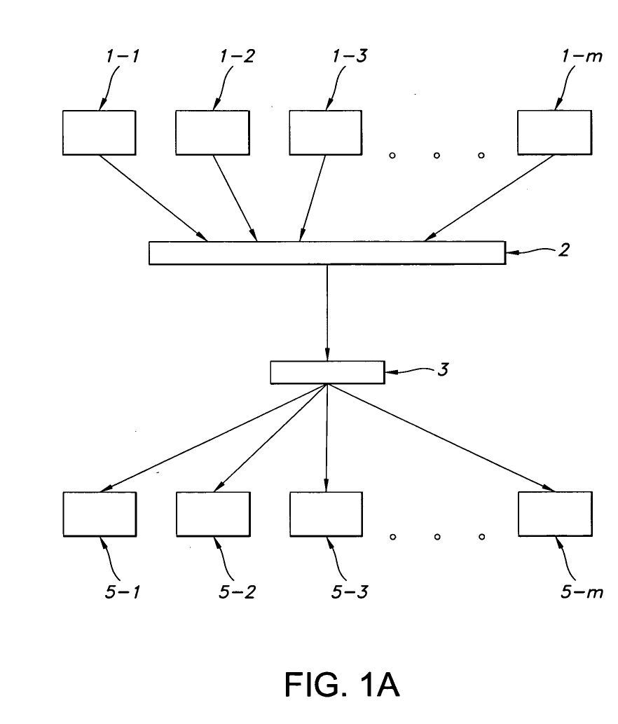

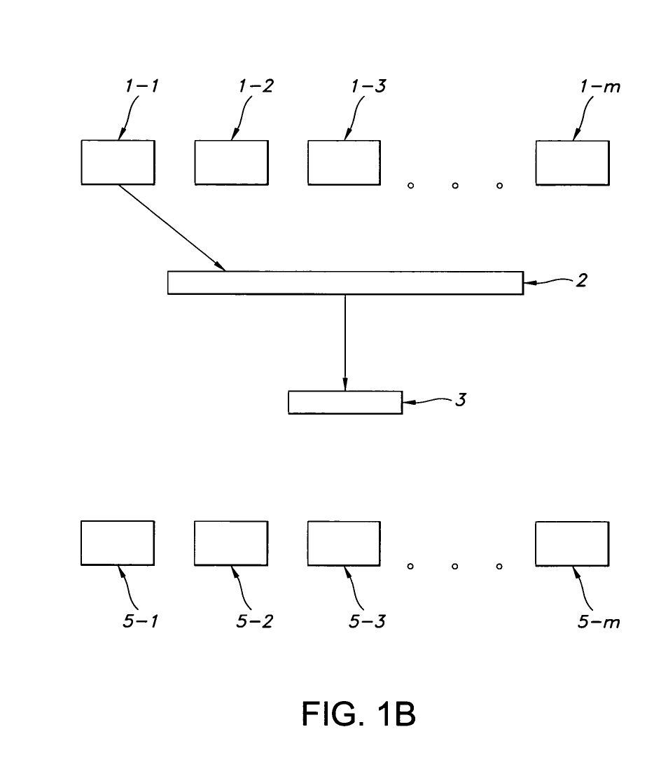

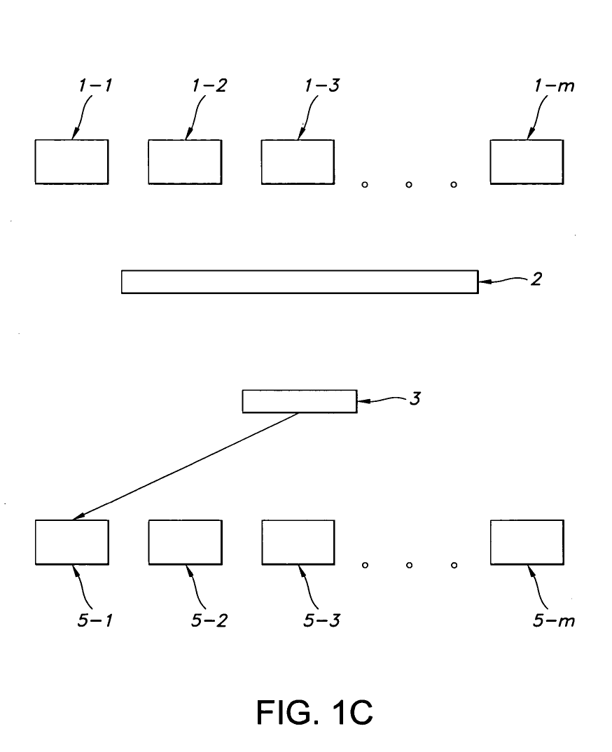

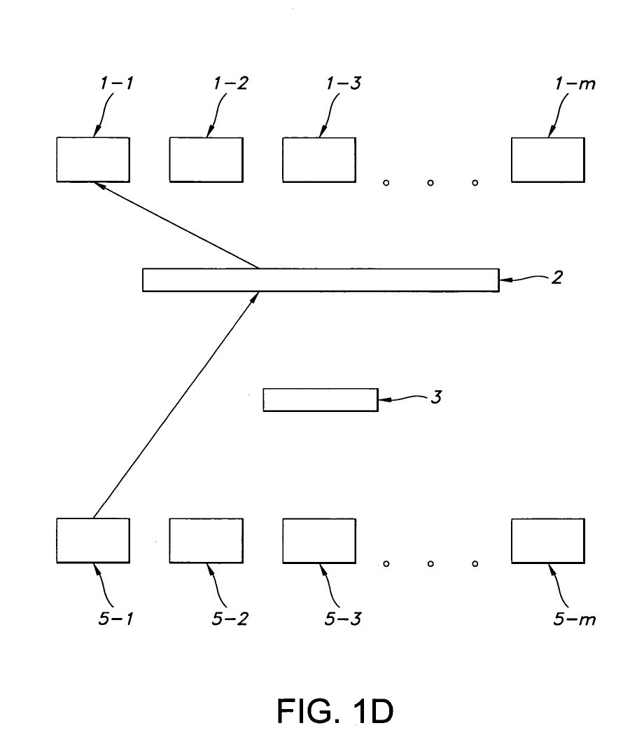

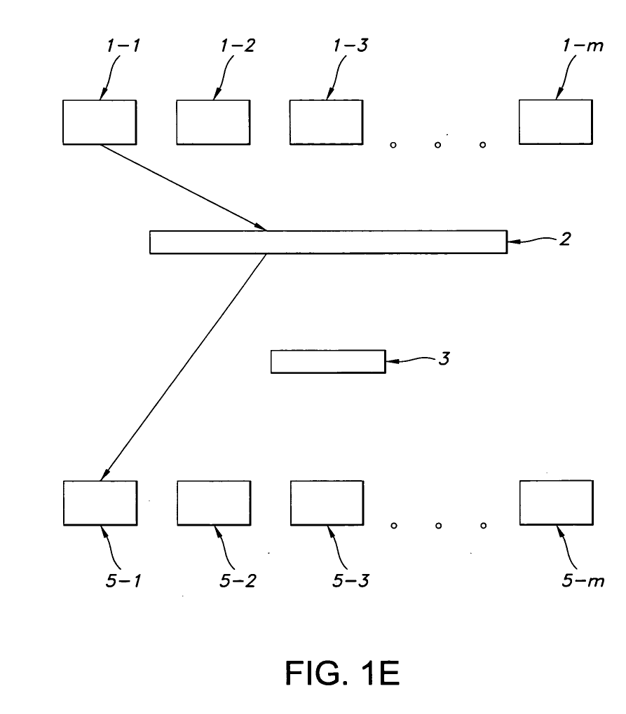

FIG. 1a, is a block diagram of the system and method of the present invention. A first embodiment of the present invention is directed towards a system and method for balancing incoming DCOM calls across a plurality of DCOM Servers within a Server cluster. With further reference to FIG. 1a, numerals 1-1, 1-2, 1-3 . . . 1-m denote DCOM Client computers which receive services from DCOM Server computers 5-1, 5-2, 5-3, . . . 5-m over a network 2 and a load balancing device 3. Network 2 is the Internet, an intranet, a local area network, a wide area network, or any other network known to those skilled in the art. With reference to FIG. 1b, Client 1-1 transmits a request across network 2 for the IP address of a DCOM Server serviced by load balancing device 3. Referring to FIG. 1c, load balancing device 3 forwards the request to available Server 5-1. Referring to FIG. 1d, Server 5-1 transmits its own unique IP address to Client 1-1. With reference to FIG. 1e, Client 1-1 uses the IP address of Server 5-1 to directly calls a DCOM Component located on that Server. Because the incoming requests from the Clients 1-1, 1-2, 1-3, . . . 1-m are balanced across Servers 5-1, 5-2, 5-3, . . . 5-m, the DCOM traffic is likewise balanced across the Servers.

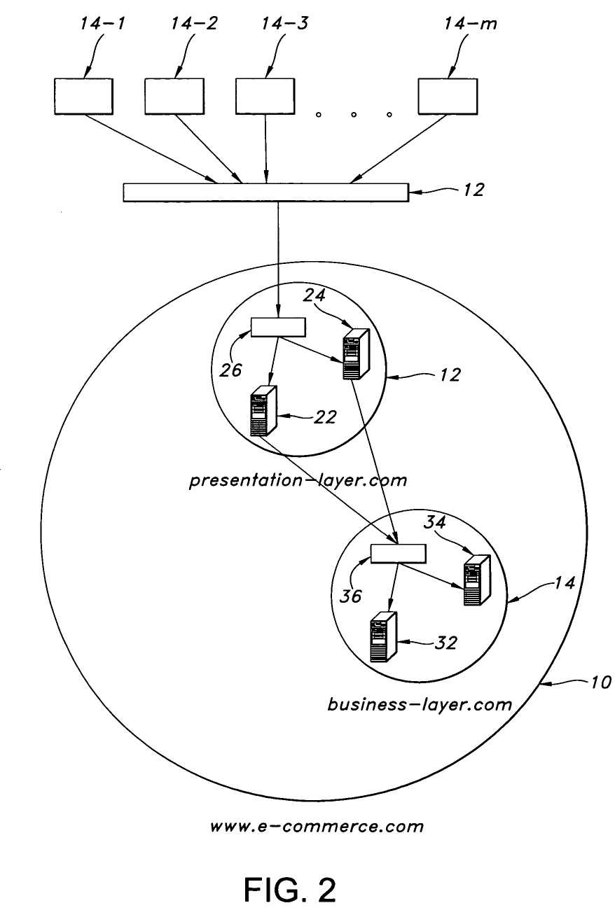

Referring to FIG. 2, a second embodiment of the present invention is disclosed, and provides a system and method of the illustrated embodiment implemented by the Web site www.e-commerce.com 10, which specializes in retail merchandising. The Web site of the illustrated embodiment relies on multiprocessor servers such as those sold by Hewlett-Packard located in Palo Alto, Calif. The Web site of the illustrated embodiment further relies on CSS Series Content Services Switches as sold by Cisco Systems Inc. of San Jose, Calif., to provide load balancing functionality for the Servers as described in further detail below. In addition, the illustrated embodiment of the present invention relies on Internet Information Server (“IIS”) software and Active Server Page (“ASP”) technology published by Microsoft Corporation, located in Redmond Wash. IIS software is well known by those skilled in the art to provide tools for controlling the operation of Web sites, such as www.e-commerce.com, while ASP is well known to those skilled in the art as a Server-side scripting environment that can be used to create interactive Web pages and build network applications. When a network Server receives a request for an ASP Web page, the Server processes Server-side scripts contained in the file to build the ASP Web page that is sent to the requestors' Web browser. In addition to Server-side scripts, ASP files can contain calls to COM or DCOM components that perform a variety of tasks, such as coupling with a database or processing business logic. The illustrated embodiment of the present invention also relies on the Hyper-Text Transfer Protocol (“HTTP”). HTTP is well known to those skilled in the are as a set of rules for exchanging data and files over a network. Although the Web site of the illustrated embodiment relies on the hardware and software described above, it would be obvious to those skilled in the art that the present invention could readily be implemented using alternative hardware and software configurations used to create and maintain Web sites.

Referring again to FIG. 2, www.e-commerce.com 10 is organized into two major tiers: a presentation tier and a business tier. The presentation tier resides on presentation-layer.com Server cluster 12, and provides the graphical user interface and application-specific entry forms or interactive windows accessed by network Clients of the www.e-commerce.com Web site 10. The business logic and rules reside on the business-layer.com Server cluster 14, and provide the business logic, rules, and databases necessary to implement www.e-commerce.com 10.

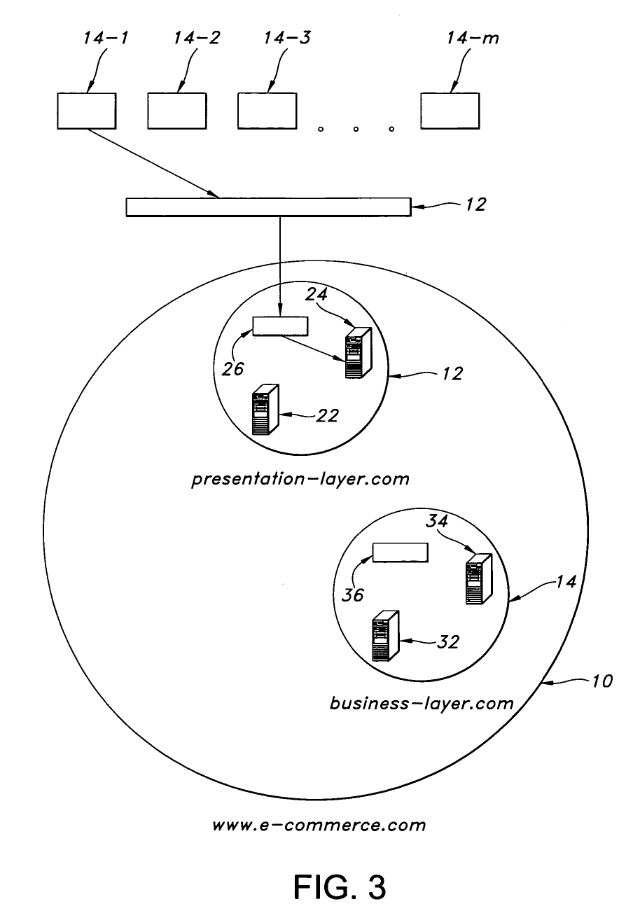

With further reference to FIG. 3, The two tiers of the Web site www.e-commerce.com 10 employ a hardware-based clustering solution that relies on load balancing devices, such as the CSS Series Content Services Switches described above, to monitor and balance incoming network traffic across the computers in each Server cluster group. Thus, each tier of the illustrated Web site www.e-commerce.com 10 is supported by two Servers and a load balancing device. Presentation-layer.com is supported by Servers 22 and 24 and load balancing device 26. Load balancing device 26 is further coupled with a network 12, such as the Internet. Business-layer.com is supported by Servers 32 and 34 and load balancing device 36. According to the illustrated embodiment of the present invention, HTTP requests made by a Client to www.e-commerce.com are transmitted over network 12 and mapped to the presentation-layer.com cluster load balancing device 26. Load balancing device 26 receives the request, determines existing loads on the Servers within the presentation-layer.com Server cluster 12, and routes the request to a particular Server within the cluster based on such factors as Server availability and the loads imposed on each Server, or any other load balancing criteria known in the art. Similarly, requests from presentation-layer.com to business-layer.com are routed by load balancing device 36 to a particular Server within the business-layer.com cluster based on Server availability and the loads imposed on each Server within that cluster.

According to the example of the illustrated embodiment of the present invention, a customer of www.e-commerce.com 10 submits a request through a Web browser running on Client 14 to purchase a product. The request may be submitted in the form of an ASP page with the relevant purchase information supplied by the customer, or a Web page from which the customer selected a product from a plurality of products sold by www.e-commerce.com, or any other on-line purchase request system or method known in the art.

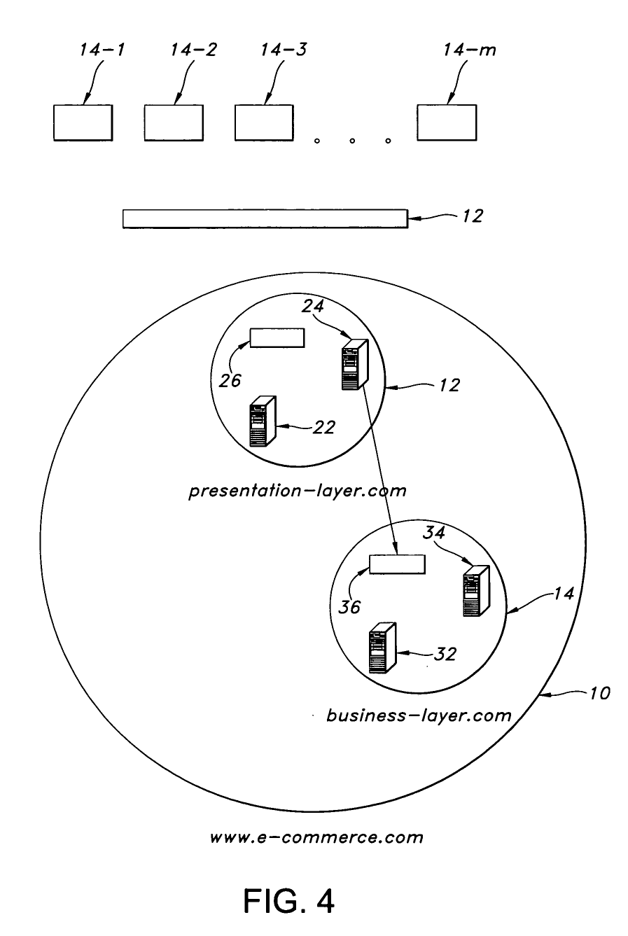

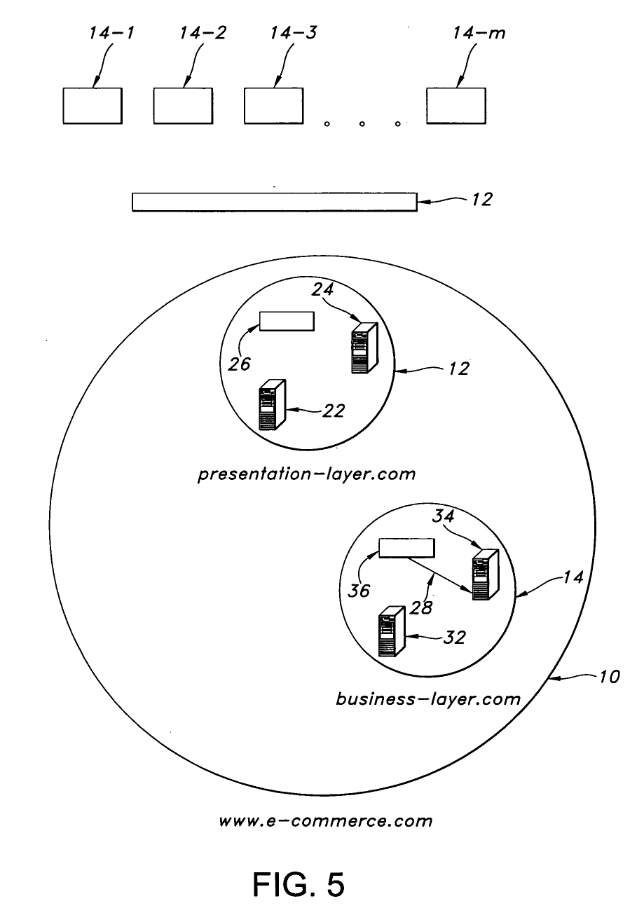

Referring to FIG. 4, the purchase request of the illustrated embodiment is forwarded by Load Balancing Device 26 to Server 24. In order to respond to purchase request, Server 24 must first determine if the item to be purchase is currently available in inventory. To determine if the item is available, Server 24 must query the Servers within the business-layer.com cluster 14 for inventory information. Because Server 24 is requesting information from the business-layer.com Server cluster, Server 24 technically becomes a Client to the business-layer.com Server cluster 14. However, to maintain consistency throughout this document, Server 24 will continue to be referred to as a Server. To retrieve inventory information from business-layer.com 14, Server 24 first issues a HTTP GET request 28 which requests the HTML page address.asp from the business-layer.com 14 Server cluster. As described in further detail below, address.asp is an HTML page which contains the unique IP address of each Server on which it resides. As shown in FIG. 5, GET request 28 is received by load balancing device 36.

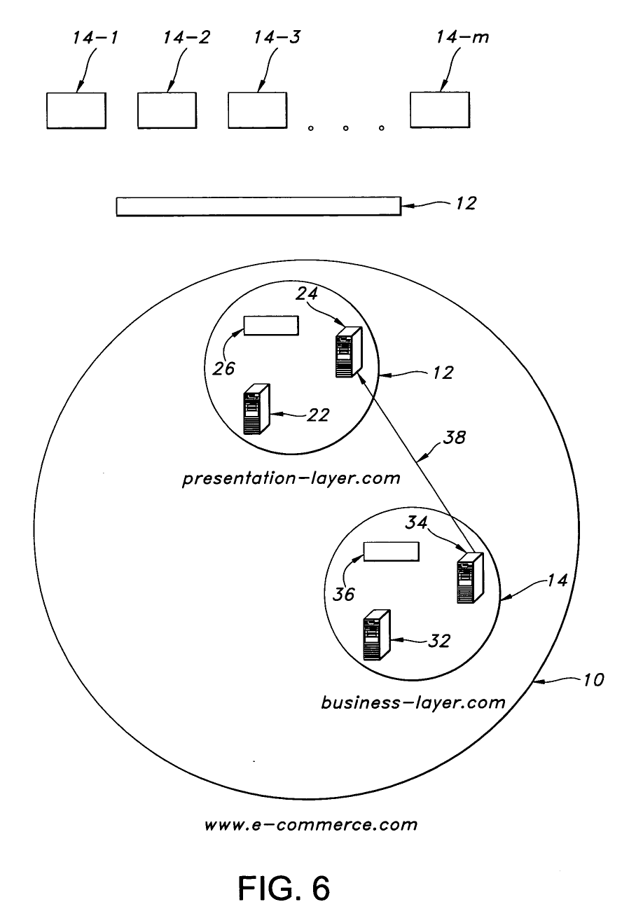

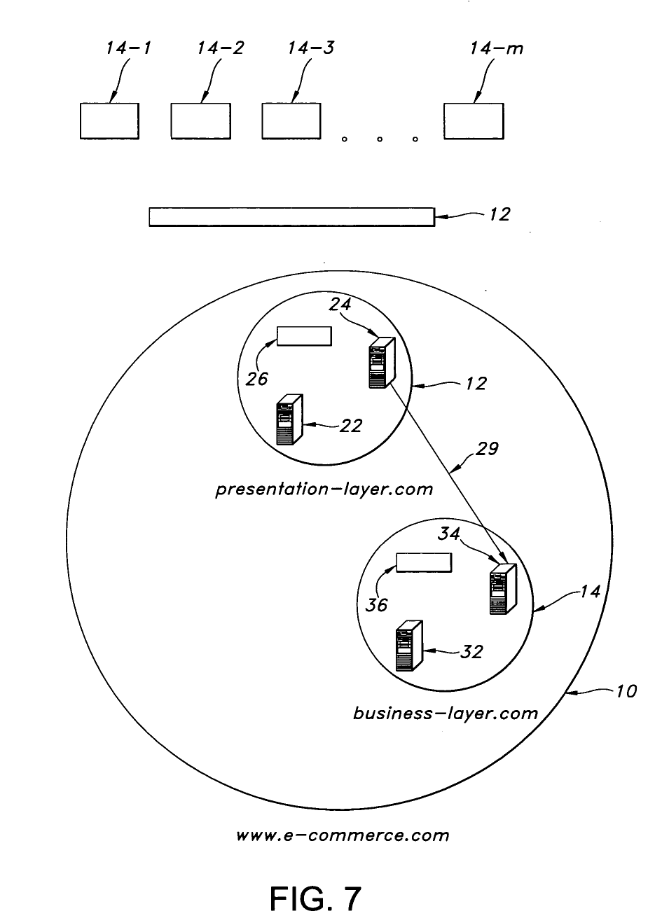

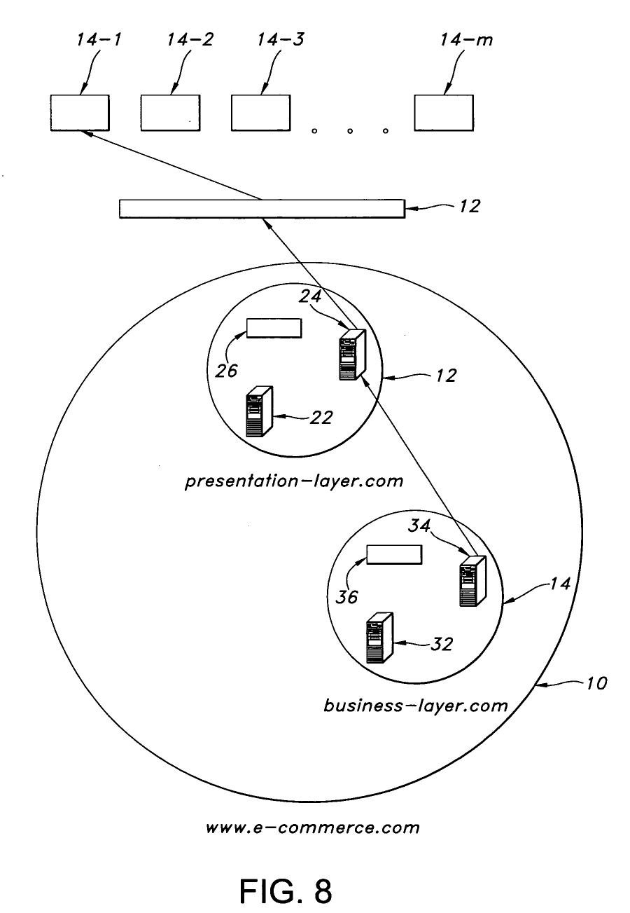

With reference to FIG. 6, load balancing device 36 forwards GET request 28 from Server 24 to Server 32. As shown in FIG. 7, Server 32 responds directly to GET request 28 by providing Server 24 with an ASP Web page entitled address.asp 38. As described in detail below, address.asp is created using Extensible Markup Language (XML). Referring to FIG. 6, Server 24 uses the IP address of Server 32 to transmit a request directly to Server 32 to invoke the DCOM component needed by Server 32 to retrieve the inventory information from a database which resides on Server 32. In this manner, all contact between the Server 24 and Server 32, in the context of the session initiated by the DCOM request, will now occur directly between Server 24 and Server 32, bypassing Load Balancing Device 36. Because the original request for address.asp was balanced across the Servers within the business-layer.com cluster, the subsequent DCOM call is likewise balanced across these Servers.

Referring to FIG. 8, Server 32 retrieves the inventory information requested by Server 24 from database. Server 34 then transmits the inventory information to Server 24. Server 24 assembles the information and transmits the inventory information to Client 14.

Address.asp

Address.asp 38 is a static ASP page that provides the unique IP address of the Server on which it resides. According to the illustrated embodiment, address.asp is located in the root directory of each Server of business-layer.com Server cluster 14. An example of the address.asp page of the illustrated embodiment is provided below. In this example, the “Request” object is used to access the ServerVariables collections. The value saved at the “LOCAL_ADDR” key is requested. The output is the address of the local machine that enclosed the Meta tag named ADDRESS. As known to those skilled in the art, the Meta tags will give the output an Extensible Markup Language (“XML”) form. The computer receiving address.asp can extract the IP address of the server sending address.asp using methods and tools well known in the art, such as Microsoft's XML Parser published by the Microsoft corporation.

<%

‘Set the response to not cache

Response.Expires=−100000

‘Write out the response in the form: ADDRESS>nnn.nnn.nnn.nnn</ADDRESS>

Response.Write “<ADDRESS>” & Request.ServerVariables(“LOCAL_ADDR”) & “</ADDRESS>”

%>

Winlnet

The Windows Internet Application Program Interface (“Winlnet API”) provides access to common Internet protocols, including FTP and HTTP. Using Winlnet, Internet client applications can be authored without having to specifically address WinSock, TCP/IP, or the details of specific Internet protocols. Winlnet provides a consistent set of functions for all three protocols, with a Win32 API interface. In particular, Winlnet can be used within a DCOM Component to request the address.asp page. However, the Winlnet library is limited to either two or four concurrent connections between a Server and the Clients being served. According to the system and method of the present invention, there is the potential for more than four concurrent connections between a Server and the Clients being served. Therefore, the system and method of the present invention relies on an alternative to Winlnet API.

According to the illustrated embodiment, the code for the alternative to the Winlnet API, referred to as Mylnet, is provided in attached Appendix I which is incorporated herein by reference. One of ordinary skill in the art who knows the hardware, software, and programmatic requirements necessary to install and execute the Winlnet ASP will know how to install and execute the referenced Mylnet.

Various modifications to the illustrated embodiment will be apparent to those skilled in the art. The general principals defined herein may be applied to other embodiments and other applications without departing from the spirit and scope of the present invention.

We claim:

1. A method for balancing Distributed Component Object (DCOM) calls among a plurality of computers, said plurality of computers comprising a client computer, a server computer, and a load balancing device, said load balancing device being coupled by a network to said client computer and said server computer, wherein the method comprises:
issuing a request, by the client computer, to the server computer for the Internet Protocol (“IP”) address of the server computer;
providing, by the server computer, the IP address of the server computer to the client computer; and
instantiating, by the client computer, a DCOM component on the server computer.

2. The method of claim 1, wherein the IP address of the server computer is contained in an extensible markup language (“XML”) file provided to the client computer by the server computer.

3. The method of claim 2, wherein the client computer parses the IP address from the XML file prior to instantiating a DCOM component on the server computer.

4. The method of claim 1, wherein the request is transmitted by the client to the load balancing device, and wherein the load balancing device transmits the request to the server.

5. The method of claim 4, wherein the DCOM component is instantiated directly by the client computer on the server computer.

6. A network load balancing method for use with a system having a Distributed Component Object Module (DCOM) environment, said method comprising:
transmitting a request from a client computer for the internet protocol (“IP”) address for at least one server computer within a server cluster comprising a plurality of server computers;
receiving said request at a load balancing device;
transmitting said request from the load balancing device to at least one server within the server cluster;
transmitting said IP address from said at least one server to said client;
transmitting a DCOM request from said client to said at least one server.

7. The network load balancing method of claim 6, wherein said transmitting of the DCOM request bypasses said load balancing device.

8. The network load balancing method of claim 6, wherein the load balancing device is configured to balance a plurality of requests across a plurality of servers within said server cluster.

9. The network load balancing method of claim 8, wherein said balancing is further comprised of analyzing the network load on said server cluster and identifying one server available to respond to said request for said IP address.

10. A network load balancing method for responding to Distributed Component Object Module (DCOM) calls across a network, the network comprising at least one client computer, a plurality of server computers, and at least one load balancing device operable to direct a DCOM call from the at least one client computer to at least one server computer of said plurality of server computers, the method comprising:
receiving a request for the Internet Protocol (IP) address of said at least one server computer;
transmitting said IP address from the said at least one server to said at least one client computer;
transmitting from said client computer to said at least one server computer a DCOM call.

11. The method of claim 10 wherein said request is transmitted by said client computer.

12. The method of claim 111, wherein said request is routed by said load balancing device to said at least one server computer.

13. The method of claim 12, wherein said DCOM call is transmitted from the client to the at least one server without passing through said load balancing device.

14. A system for balancing Distributed Component Object (DCOM) calls among a plurality of computers, said system comprising:
a client computer configured to communicate across a computer network;
a server cluster comprising a plurality of server computers configured to provide DCOM resources to a Client;
a load balancing device configured to substantially equalize network traffic across said plurality of server computers within said server cluster, said load balancing device being coupled to said client computer and said plurality of server computers within said server cluster;

15. A method for allocating Distributed Component Object (DCOM) calls among a plurality of computers, said plurality of computers comprising a client computer, a server computer, and a cluster device, said cluster device being coupled by a network to said client computer and said server computer, wherein the method comprises:
issuing a request, by the client computer, to the server computer for the Internet Protocol (“IP”) address of the server computer;
providing, by the server computer, the IP address of the server computer to the client computer; and
instantiating, by the client computer, a DCOM component on the server computer.

16. The method of claim 15, wherein the request is transmitted by the client to the cluster device.

17. The method of claim 16, wherein the cluster device transmits the request to the server.

18. The method of claim 17, wherein the client directly instantiated the DCOM component on the server.

19. The method of claim 17, wherein the IP address is provided by the server in the form of an application server page (“ASP”).

20. A method for communicating requests for DCOM services across a network, said network comprising a client computer, a server computer cluster further comprising a plurality of server computers, and a load balancing device, said load balancing device being coupled with said client and said server cluster, said method comprising the steps of:
receiving a request at the load balancing device from the client, the request being for an IP address of at least one server within the server cluster;
transmitting the request from the load balancing device to at least one server within the server cluster;
transmitting the IP address from the at least one server to the client;
transmitting a DCOM request from the client to the at least one server, wherein the transmitting of the DCOM request bypasses the load balancing device.
